(19) United States
(12) Patent Application Publication
(10) Pub. No.: US 2023/0113684 A1
(43) Pub. Date: Apr. 13, 2023

(54) METHOD AND APPARATUS FOR DETECTION AND INDICATION OF FAULTY ROADSIDE UNIT

(71) Applicant: Harman International Industries, Incorporated, Stamford, CT (US)

(72) Inventors: Prasanna Kumar Bolisetty Yeswanth Naga, Bangalore (IN); Kirubasankar Madhaiyan, Bangalore (IN)

(21) Appl. No.: 17/935,713

(22) Filed: Sep. 27, 2022

(30) Foreign Application Priority Data
Oct. 8, 2021 (IN) 202141045871

(51) Int. Cl. H04W 24/08; G01S 19/42; H04W 76/10

(52) U.S. Cl. CPC H04W 24/08; G01S 19/42; H04W 76/10

(57) ABSTRACT

Methods and systems are described for a detecting a faulty condition of a roadside unit (RSU) and generating, in response to the detection of the faulty condition, a predetermined distress transmission for broadcast over a wireless interface of the RSU. The distress transmission may be received by on-board units (OBUs) of vehicles and pedestrian devices and relayed to nearby RSUs to inform an operation center of the faulty condition of the RSU.

### CROSS-REFERENCE TO RELATED APPLICATIONS

The present application claims priority to Indian Patent Application No. 202141045871, entitled “METHOD AND APPARATUS FOR DETECTION AND INDICATION OF FAULTY ROADSIDE UNIT,” and filed on Oct. 8, 2021. The entire contents of the above-listed application is hereby incorporated by reference for all purposes.

### FIELD

The disclosure relates to methods and apparatuses for detection and indication of a faulty roadside unit in an intelligent transportation system.

### BACKGROUND

An intelligent transportation system (ITS) serves radio communication between a roadside unit (RSU) installed by a roadside or by a traffic pole, and an on-board unit (OBU) mounted on a vehicle, using a dedicated short-range communication (DSRC)/cellular vehicle-to-everything (CV2X) or other wireless communication medium. A DSRC/CV2X or other wireless communication medium enables connected vehicle applications that may reduce vehicle crashes by connecting a transportation system using integrated wireless devices (e.g., OBUs) and road infrastructure (e.g., RSUs). In such a connected system, data and messages among vehicles configured with OBUs and road infrastructure are exchanged with acceptable time delay. DSRC/CV2X enables communication between a vehicle and any DSRC/CV2X equipped object—e.g., vehicle-to-everything (V2X) communication—and provides a 360-degree field of view with long-range detection and communication capability, up to 1000 meters for DSRC and a few kilometers (e.g., approximately 5 kilometers) for CV2X. Data such as vehicle position, dynamics, and signals may be exchanged among vehicles and with the road infrastructure, which allows for deployment of safety applications, such as warning and control crash avoidance systems.

When a vehicle mounted with an OBU passes through a communication zone formed by antennas of an RSU, the RSU provides various information and services to the vehicle. A variety of services may be provided by the ITS according to frequency channels allocated to each RSU. Accordingly, when the OBU enters the communication zone of the RSU, the OBU searches a channel of the RSU by performing a channel search operation and performs an initialization process to receive information or other services from the RSU.

The RSU may periodically broadcast wireless access in vehicular environments (WAVE) service advertisement (WSA) and/or WAVE short message (WSM) messages to the OBU to ensure hassle-free multiple OBU commutation (e.g., WSA protocol compliant and/or WAVE WSM protocol compliant messages). In some embodiments, the RSU may also broadcast similar messages in accordance with other standards (e.g., regional standards in China, Europe, Japan, Korea, et cetera). Examples of WSM messages using DSRC include signal phase and timing (SPaT) messages, messages corresponding with map data to convey geographic road information (MAP messages, e.g., MAP protocol compliant messages), and traveler information messages (TIM messages, e.g., TIM protocol compliant messages). Other standards (e.g., regional standards, as mentioned above) may communicate RSU messages other than SPaT messages or MAP messages, such as roadside messages and/or roadside information messages. The OBU switches to the appropriate channel based on messages broadcast by the RSU. In an urban city and freeway example, multiple RSUs are deployed to transmit and receive WSA and/or WSM messages for smooth and safe traffic commutation.

### SUMMARY

In an ITS, data and messages among vehicles configured with OBUs and road infrastructure may be exchanged with acceptable time delay. However, data and messages indicating an RSU faulty status may not be relayed in real time to vehicles configured with OBUs and to road infrastructure, which may result in delayed notification to elements of the ITS regarding the RSU faulty status. Delayed notification of the RSU faulty status may result in unsafe driving conditions, as elements of the ITS may operate as if each RSU of the ITS is operational. If, for example, a TIM message is not relayed to a vehicle driver (e.g., a user and/or an autonomous drive system) using DSRC communication due to the RSU faulty status, the vehicle driver may not be notified of an upcoming road hazard via an OBU, which may result in the vehicle driving through hazardous conditions. In accordance with other wireless communication standards—for example, in accordance with regional standards in China, Europe, Japan, Korea, et cetera—RSU messages may be in forms other than TIM messages.

Disclosed herein are methods and mechanisms for detecting a faulty condition of an RSU and generating, in response to the detection of the faulty condition, a predetermined distress transmission for broadcast over a wireless interface of the RSU. The methods and mechanisms may minimize a downtime of a faulty RSU by indicating the faulty condition in real time, which may decrease an amount of time between an event causing the faulty condition and repair of the faulty condition, compared to other methods in which there may be a time delay between the event causing the faulty condition and indication of the faulty condition. Additionally, the method described herein may notify a vehicle driver of the faulty condition via an OBU of the vehicle, and the vehicle driver may then adjust driving controls to accommodate for the faulty RSU. The OBU of the vehicle may in turn inform other nearby OBUs of the faulty RSU (e.g., an OBU implemented in a vehicle and/or pedestrian device), which may implement respective control adjustments to accommodate for the faulty RSU.

Embodiments are disclosed for a method comprising detecting a faulty condition of an RSU and generating, in response to the detection of the faulty condition, a predetermined distress transmission for broadcast over a wireless interface of the RSU. An apparatus of the RSU comprises a wireless interface for sending transmissions to OBUs, one or more processors, and a non-transitory memory having executable instructions that, when executed, cause the one or more processors to execute the method described above.

The RSU may be implemented in a system for detection and indication of a faulty RSU, comprising the RSU, an operation center in wired communication with the RSU, and an OBU comprising one or more processors and a non-transitory memory having second executable instructions that, when executed, cause the one or more processors to process the predetermined distress transmission, which may include forwarding the distress transmission to a nearby RSU, which may be configured in a manner similar to the aforementioned RSU. The nearby RSU may then relay the distress transmission to the operation center, which may adjust messages sent to the faulty RSU and the nearby RSU regarding control of the system (e.g., an intelligent traffic system).

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The disclosure may be better understood from reading the following description of non-limiting embodiments, with reference to the attached drawings, wherein below:

FIG. 1 shows a first scenario of a faulty roadside unit (RSU) mechanism in which backhaul connectivity is down, in accordance with one or more embodiments of the present disclosure;

FIG. 2 shows a second faulty RSU mechanism in a scenario in which backhaul connectivity is up with abnormal functioning of the RSU, in accordance with one or more embodiments of the present disclosure;

FIG. 3 shows an RSU with wireless devices for distress signal broadcasting, in accordance with one or more embodiments of the present disclosure;

FIG. 4 shows a scenario in which a third faulty RSU mechanism communicates a distress signal to nearby on-board units (OBUs) and RSUs, in accordance with one or more embodiments of the present disclosure;

FIG. 5 shows a protocol for broadcasting and detecting an RSU distress signal, in accordance with one or more embodiments of the present disclosure; and

FIG. 6 shows an example method for detecting a faulty RSU condition and broadcasting an RSU distress signal, in accordance with one or more embodiments of the present disclosure; and

FIG. 7 shows a system for detection and indication of faulty RSUs, in accordance with one or more embodiments of the present disclosure.

### DETAILED DESCRIPTION

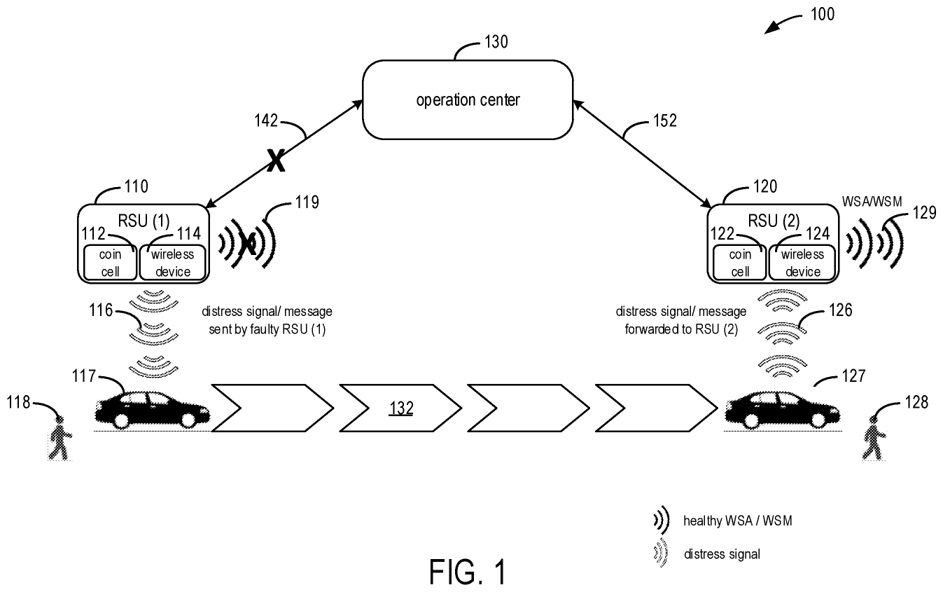

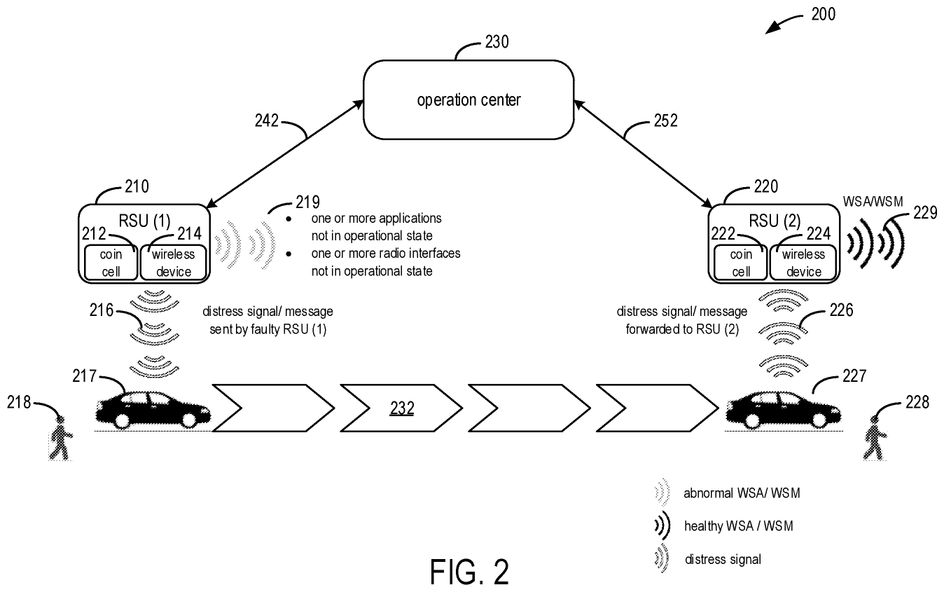

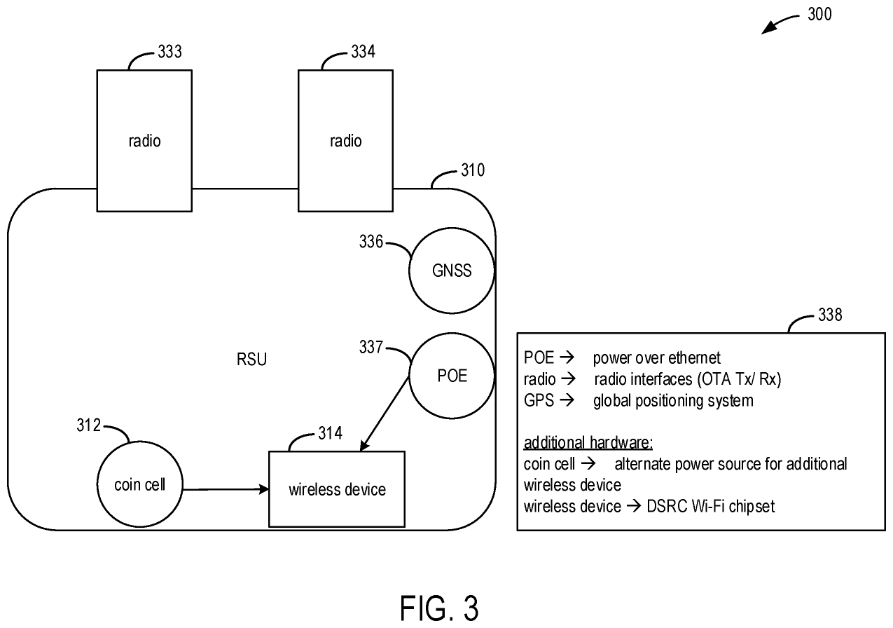

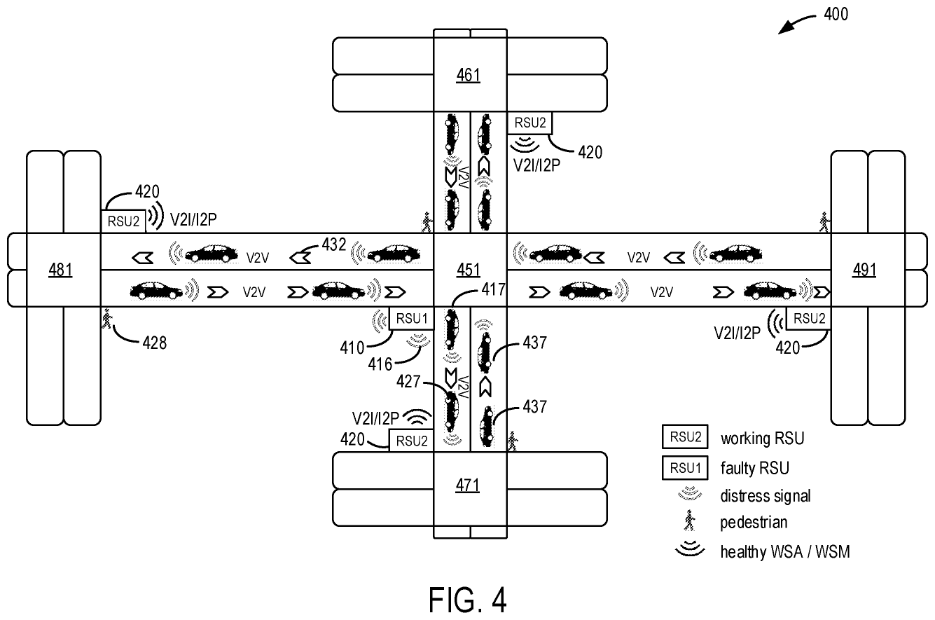

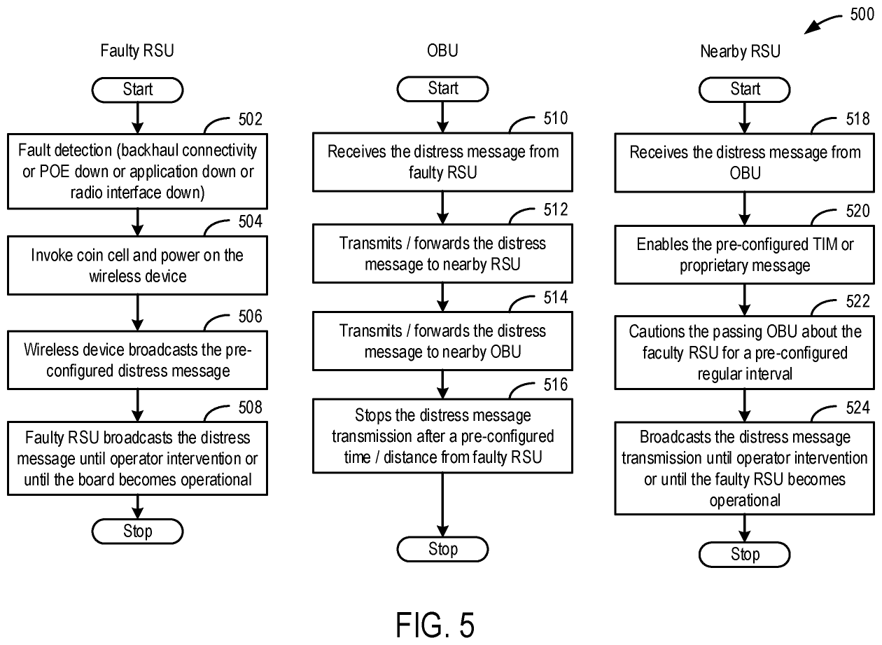

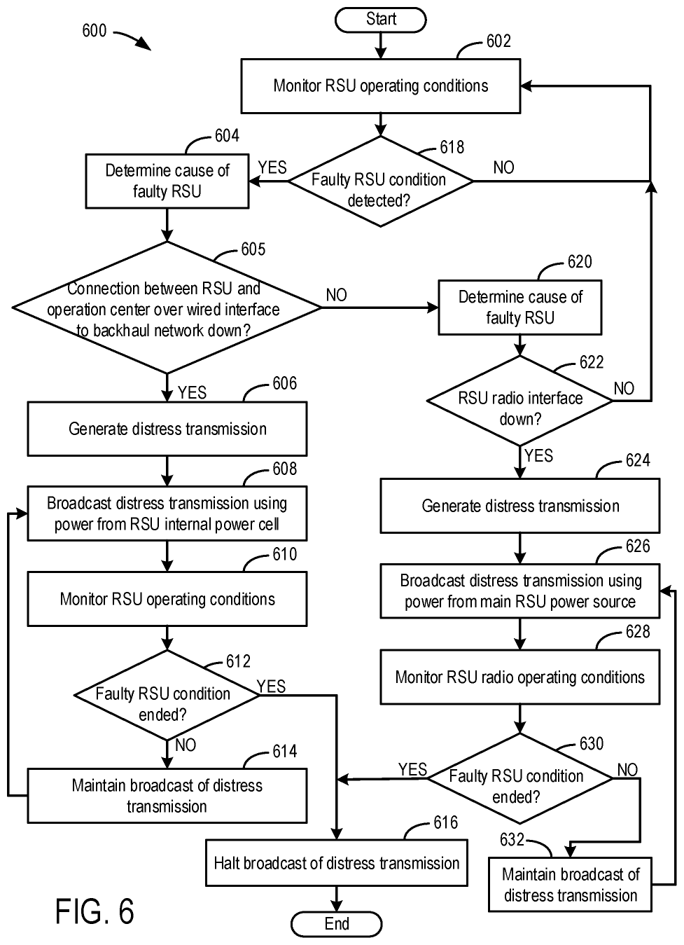

Intelligent transportation systems (ITS) may be designed to allow for real-time adjustment of traffic control (e.g., traffic signals, speed limits, lane closures, et cetera) based on traffic conditions (e.g., number of vehicles and/or pedestrians, weather, collisions, construction, et cetera). A first ITS is shown in FIG. 1, including an operation center, roadside units (RSUs), vehicles, and pedestrians. The vehicles and pedestrians may include devices configured with an on-board unit (OBU) which may receive signals from nearby RSUs and other OBUs through wireless communication. In FIG. 1, a first RSU may be faulty due to a break in connection with the operation center. A second ITS is shown in FIG. 2, having similar elements to FIG. 1. In FIG. 2, a first RSU may be faulty due to at least one non-operational radio interface. FIGS. 1 and 2 each illustrate a method by which a distress signal generated and broadcast by the first RSU may be relayed to the operation center. FIG. 3 shows a schematic of an RSU (for example, one of the RSUs of FIGS. 1-2) including elements which may cause a faulty RSU condition (e.g., a faulty condition of the RSU), as well as elements which may be used to generate and broadcast the distress signal. FIG. 4 shows a third example ITS demonstrating how a distress signal from a faulty RSU may be transmitted among multiple nearby RSUs, vehicles, and pedestrians. An example protocol which may be implemented in FIG. 4 is described in FIG. 5 to illustrate actions of a faulty RSU, an OBU, and a nearby RSU. A method of the faulty RSU is further described in FIG. 6, showing how the distress signal may be generated and broadcast.

FIG. 1 shows a first scenario of a faulty roadside unit (RSU) mechanism in which backhaul connectivity is down. An intelligent transportation system (ITS) 100 may include a first RSU 110, a second RSU 120, an operation center 130, a first vehicle 117, a second vehicle 127, a first pedestrian 118, and a second pedestrian 128. The first RSU 110 and the second RSU 120 may each facilitate communication between transportation infrastructure (e.g., the operation center 130), vehicles (e.g., the first vehicle 117 and/or the second vehicle 127), and other mobile devices (e.g., mobile devices held by the first pedestrian 118 and/or the second pedestrian 128), such as by exchanging safety messages between a vehicle and any DSRC/CV2X and/or similar wireless communication method equipped object (V2X safety messages) over a wireless communication medium. Appropriate wireless communication mediums may include Wi-Fi DSRC protocol compliant mediums, cellular-V2X protocol (e.g., 4G) compliant mediums, and/or Fifth Generation broadband cellular network (5G) protocol compliant mediums, in compliance with automotive standards and/or region specific standards.

The first RSU 110 and the second RSU 120 may communicate with a traffic controller through a wired medium, may communicate with a backhaul network (e.g., for operation, maintenance, big-data collection, security services, and external Cloud services) through a wired medium, and/or may communicate with on-board units (OBUs) and mobile devices over the air (OTA) through one or more wireless communication mediums including Wi-Fi DSRC protocol compliant mediums, cellular-V2X protocol (e.g., 4G) compliant mediums, and/or cellular 5G protocol compliant mediums. Further details regarding communication over the wireless communication medium are described with respect to FIGS. 2-6.

The first RSU 110 and the second RSU 120 may be configured with a “coin cell” battery (e.g., a first coin cell 112 of the first RSU 110 and a second coin cell 122 of the second RSU 120) and a wireless device (e.g., a first wireless device 114 of the first RSU 110 and a second wireless device 124 of the second RSU 120). The first RSU 110 and the second RSU 120 are each further configured with at least two radio interfaces (not shown) for broadcasting signals generated by the respective RSU via DSRC/CV2X wireless communication. A wired power source (not shown) is included in each of the first RSU 110 and the second RSU 120 as a main power source. Additionally, each of the first RSU 110 and the second RSU 120 are configured with a global navigation satellite system (not shown) for providing information to the operation center 130 regarding a position of the respective RSU.

The first vehicle 117, the second vehicle 127, the first pedestrian 118, and the second pedestrian 128 may each be configured with an OBU (not shown). For example, the first vehicle 117 and the second vehicle 127 may each have an OBU installed during vehicle manufacturing or as an after-market modification. The first pedestrian 118 and the second pedestrian 128 may carry an OBU integrated into a smart phone, smart watch, tablet, computer, or other personal technology.

The operation center 130 may provide a variety of services according to frequency channels allocated to each RSU. For example, the operation center 130 may inform the first RSU 110 and the second RSU 120 of traffic signal status, vehicle concentration on the roadway, weather conditions, pedestrian presence and/or location, and so on. Additionally, the operation center 130 may receive messages from the first RSU 110 and the second RSU 120 regarding an RSU operating status.

Elements of the ITS 100, as described above, may be in wired communication and/or wireless communication via dedicated short-range communication (e.g., DSRC/CV2X). For example, the operation center may be in wired communication or wireless communication with the first RSU 110 and the second RSU 120. The first RSU 110 may be in wireless communication with the second RSU 120, the first vehicle 117, and the first pedestrian 118. For example, the wireless device 114 may generate a distress signal and broadcast the distress signal via the at least two radio interfaces (not shown) of the first RSU 110. The distress signal may be received by a first OBU of the first vehicle 117 and a third OBU of the first pedestrian 118. The first OBU of the first vehicle 117 may be in wireless communication with a second OBU of the second vehicle 127 and/or a fourth OBU of the second pedestrian 128. For example, the first OBU may forward the distress signal received from the first RSU 110 to the second OBU of the second vehicle 127 and/or the fourth OBU of the second pedestrian 128 via wireless communication. Additionally, the third OBU of the first pedestrian 118 may be in wireless communication with the first OBU (of the first vehicle 117), the second OBU (of the second vehicle 127), and the fourth OBU of the second pedestrian 128. For example, the first OBU may forward the distress signal to the third OBU and the third OBU may forward the distress signal to the second OBU and the fourth OBU.

In the scenario of FIG. 1, backhaul connectivity may be down for the first RSU. For example, backhaul connectivity may be down when a wired or wireless connection 142 between the operation center 130 and the first RSU 110 is down. This may be a result of the connection between the operation center 130 and the first RSU 110 being unintentionally or intentionally powered down, tampered, or isolated. In such cases, the operation center 130 may be unable to communicate with the first RSU 110. As a result, messages sent both from the operation center 130 to the first RSU 110 and from the first RSU 110 to the operation center 130 might not be received. When backhaul connectivity is down, messages among the first RSU 110 and the operation center 130 regarding traffic signal status, vehicle concentration on the roadway, weather conditions, pedestrian presence, and so on might not be transmitted, and might not be relayed to any of the first or second OBUs, and therefore might not be further relayed to the third OBU and/or the fourth OBU. This may result in vehicle crashes or other unsafe conditions, as the operation center 130 may have limited information regarding relative OBU positions, and therefore may have limited information regarding vehicle and/or pedestrian positions within ITS 100.

In the example of FIG. 1, when backhaul connectivity is down (as shown by a break in the connection 142 between the operation center 130 and the first RSU 110), the first RSU 110 may broadcast a distress signal to inform the operation center 130; one or more of the first OBU, the second OBU, the third OBU, and the fourth OBU; and the second RSU 120 of the backhaul connectivity status. Accordingly, upon indication of the break in the connection 142, the first RSU 110 may halt broadcasting of a healthy WSA and/or WSM signal 119, and may broadcast a distress signal/message 116 (e.g., for oncoming OBUs) indicating the first RSU 110 to be faulty.

As backhaul connectivity is connected via a wired connection, backhaul connectivity being down may also result in a disconnect from an external wired power source. The wired power source may be the main RSU power source. When power from the main RSU power source for the first RSU 110 is cut off, such as when backhaul connectivity is down, the coin cell 112 may provide power to the wireless device as a secondary power source. The coin cell 112 may switch off when power is supplied from the main RSU power source, such as when backhaul connectivity is restored. As backhaul connectivity between the second RSU 120 and the operation center 130 is maintained, the second RSU 210 is powered by the respective main RSU power source. RSU power sources are further described in FIG. 3.

The distress signal and/or message 116 may be preconfigured and broadcast (e.g., for oncoming OBUs) at a configured interval. The distress signal and/or message 116 may be received by the first OBU of the first vehicle 117 and may be transmitted via a wireless transmission 132 to the second OBU of the second vehicle 127. The distress signal and/or message 116 may then be forwarded by the second OBU of the second vehicle 127, via a wireless transmission 126, to the second RSU 120. The second RSU 120 may continue broadcasting a healthy WSA and/or WSM 129, indicating a non-faulty condition of the second RSU 120, and may also forward the distress signal and/or message 116 to the operation center 130 via wired or wireless connection 152, indicating the faulty status of the first RSU 110.

In this way, the faulty status of the first RSU 110 may be communicated to the operation center 130, OBUs (and therefore vehicles and pedestrians), and RSUs in proximity to the first RSU 110 within ITS 100. The operation center may then adjust messages sent to RSUs in proximity to the first RSU 110, e.g., the second RSU 120, to inform RSUs and OBUs of a location and operating status of the faulty first RSU 110. Further detail regarding broadcast and receipt of distress signals is discussed in FIGS. 4-6.

FIG. 2 shows a second scenario of a faulty RSU mechanism in which backhaul connectivity is up with abnormal functioning of the RSU. Various elements of FIG. 2 may be substantially similar to similarly-numbered and similarly-depicted elements of FIG. 1 are. For example, the first RSU 110 of FIG. 1 is substantially similar to a first RSU 210 of FIG. 2.

In the scenario of FIG. 2, backhaul connectivity between an operation center 230 and a first RSU 210 may be functional, as indicated by a wired or wireless connection 242 between the operation center 230 and the first RSU 210; however, a status of elements of the first RSU 210 may be faulty. For example, one or more radio interfaces of the first RSU 210 (e.g., communication between radios of the RSU and elements of the ITS) may be non-operational or non-transmitting, and/or one or more enabled applications of the RSU may be in a non-operational state. In such cases, nominal function of the first RSU 210 may be limited. For example, the first RSU 210 may be unable to relay to a first OBU of a first vehicle 217 or a second OBU of a first pedestrian 218 a location of proximate OBUs (e.g., other vehicles and pedestrians). Additionally, messages from the first RSU 210 regarding traffic signal status, vehicle concentration on the roadway, weather conditions, pedestrian presence, and so on might not be transmitted to the first OBU of the first vehicle 217 and the second OBU of the first pedestrian 218, and therefore might not be further relayed to any oncoming OBUs. This may result in vehicle crashes or other unsafe conditions, as the operation center 230 may have limited information regarding relative OBU positions, and therefore may have limited information regarding vehicle and/or pedestrian positions within ITS 200 to relay to the first RSU 210 and further to the first vehicle 217 (which might otherwise be used to influence and/or control position, speed, and so on of the first vehicle 217).

In the example of FIG. 2, when backhaul connectivity is up but the first RSU 210 has abnormal functioning, the first RSU 210 may broadcast an abnormal signal 219 indicating any one or all applications are not in the operational state and/or any one or all radio interfaces are not in the operational state. Further, the first RSU 210 may broadcast a distress signal and/or message 216 to inform the operation center 230; one or more of the first OBU of the first vehicle 217, the second OBU of the first pedestrian 218, a third OBU of a second vehicle 227, and a fourth OBU of a second pedestrian 228; and a second RSU 220 of the faulty status of the first RSU 210. Accordingly, upon indication of the abnormal functioning of the first RSU 210, the first RSU 210 may halt broadcasting of a healthy WSA and/or WSM signal and broadcast the distress signal and/or message 216 (e.g., for oncoming OBUs), indicating the first RSU 210 to be faulty.

As backhaul connectivity is maintained during abnormal operation of the first RSU 210, the first RSU may be supplied power by a main wired power source (not shown). The first coin cell 212 may be switched off, as the wired power source may supply power used to generate and broadcast the distress signal and/or message via the first wireless device 214 and the at least two radio interfaces (not shown) of the first RSU 210.

The distress signal and/or message 216 may be preconfigured and broadcast (e.g., for oncoming OBUs) at a configured interval. The distress signal and/or message 216 may be received by the first OBU of the first vehicle 217 and may be transmitted via a wireless transmission 232 to the second OBU of the second vehicle 227. The distress signal and/or message 216 may then be forwarded by the second OBU of the second vehicle 227, via a wireless transmission 226, to the second RSU 220. The second RSU 220 may continue broadcasting a healthy WSA and/or WSM 229, indicating a non-faulty condition of the second RSU 220, and may also forward the distress signal and/or message 216 to the operation center 230 via a wired or wireless connection 252, indicating the faulty status of the first RSU 210.

In this way, the faulty status of the first RSU 210 may be communicated to the operation center 230, OBUs (and therefore vehicles and pedestrians), and RSUs in proximity to the first RSU 210 within ITS 200. The operation center may then adjust messages sent to RSUs in proximity to the first RSU 210, e.g., the second RSU 220, to inform RSUs and OBUs of a location and operating status of the faulty first RSU 210. Further detail regarding broadcast and receipt of distress signals is discussed in FIGS. 4-6.

FIG. 3 shows an RSU system 300 with wireless devices for distress signal broadcasting. The RSU system 300 includes an RSU 310 (which may be substantially similar to the RSUs shown in FIGS. 1-2). A legend 338 further describes elements of the RSU 310 which may be used to generate and broadcast healthy WSA and/or WSM signals, abnormal WSA and/or WSM signals, and distress signals.

The RSU 310 comprises one or more processors (not shown) and a non-transitory memory (not shown) having executable instructions that, when executed, cause the one or more processors to detect a faulty condition of the RSU, generate, in response to the detection of the faulty condition, a predetermined distress transmission, and broadcast the predetermined distress transmission over the wireless interface. In various embodiments, the predetermined distress transmission may include one or more of: a unique RSU identifier (ID), e.g., a value uniquely identifying an RSU; a three-dimensional (3D) location, e.g., a value identifying a location; and an intersection ID, e.g., a value uniquely identifying an intersection.

The RSU 310 may facilitate communication between transportation infrastructure, vehicles, and other mobile devices (e.g., as described in FIGS. 1-2) by exchanging V2X safety messages over a wireless communication medium, which may include Wi-Fi DSRC protocol compliant mediums, cellular-V2X protocol (e.g., 4G) compliant mediums, and 5G protocol compliant mediums, in compliance with automotive standards and region specific standards.

The RSU 310 may be integrated with a backhaul system, such as in FIG. 1, which may enable remote management (e.g., operation and maintenance) of the RSU 310, and may provide RSU services and/or applications delivered by back office service providers to vehicles and other devices (e.g., devices configured with an OBU capable of communication with at least one RSU). Additionally, RSU 310 may be incorporated with local traffic control systems (e.g., an intersection traffic controller) to deliver traffic management services to vehicles and/or other mobile devices configured with an OBU. Traffic management services delivered by the RSU 310 are further described in FIGS. 4-6.

The RSU 310 may be configured with a first radio 333 and a second radio 334. The first radio 333 and the second radio 334 may broadcast signals generated by the RSU 310 via DSRC/CV2X. In one example, a broadcasting range may include a 360-degree field of view and a long range detection and/or communication capability of up to 1000 meters. As described in the legend 338, the first radio 333 and the second radio 334 may be radio interfaces configured with OTA transmission and receiving capabilities for wireless signals (e.g., OTA transmitting and/or receiving interfaces). The first radio 333 and the second radio 334 may have different broadcasting capabilities such that different RSU messages such as WSA messages, TIM messages, SPaT messages, MAP messages, and so on may be configured to broadcast in a specific radio or antenna. For example, the first radio 333 may be a primary radio used for broadcasting WSA and TIM messages (e.g., using V2X channel 178), and the second radio 334 may be used for additional services, for example, SPaT messages, MAP messages, and so on (e.g., using V2X channel 172). Further details regarding RSU radio operation is described in FIG. 5.

The RSU 310 is further configured with a global navigation satellite system (GNSS) 336 for providing information to an operation center (e.g., the operation center 130 of FIG. 1) regarding a position of the RSU 310. The GNSS 336 may be configured as a global positioning system (GPS).

The RSU 310 is also configured with a power over Ethernet (POE) device 337, as defined in the legend 338, which may be used to provide a wired source of electric power to the RSU 310. Additionally, the POE device 337 may provide a wired data connection, for example, between the RSU 310 and the operation center. The wired source of electric power provided by the POE device 337 may be used as a main power source for the RSU 310.

As briefly described in FIGS. 1-2, the RSU 310 is configured with a coin cell 312 and a wireless device 314. The wireless device 314 may be a DSRC Wi-Fi chipset, as defined by the legend 338, which may broadcast a preconfigured distress signal and/or message (e.g., to oncoming OBUs) at a configured interval when powered, as briefly described in FIGS. 1-2 and further described in FIGS. 4-6. In FIG. 3, the RSU 310 is depicted as being configured with one wireless device; however, other embodiments of the RSU 310 may include more than one wireless device. The wireless device 314 may be powered by the POE device 337 or by the coin cell 312. A coverage range of the wireless device 314 may be the same as a coverage range of the RSU 310, or may have a configured different coverage range.

The coin cell 312 may be an alternate power source for the wireless device 314, as defined in the legend 338, and may provide power to the wireless device 314 when a main power source (e.g., POE 337) might not be providing power to the wireless device 314. For example, the coin cell 312 may provide power to the wireless device 314 upon a loss or fluctuation of power provided by the main power source. More detail regarding power sources is described in FIGS. 4-6.

FIG. 4 shows a scenario in which a third faulty RSU mechanism communicates a distress signal to nearby OBUs and RSUs. As depicted in FIG. 4, a first RSU 410 (toward the center of the figure) is indicated to be faulty. A faulty status of the first RSU 410 may be due to a backhaul connectivity being down, as described in FIG. 1, an abnormally functioning RSU, as described in FIG. 2, or other circumstances resulting in a faulty RSU 410. The first RSU 410 may broadcast a distress signal 416, which may be broadcast over a communication zone of the first RSU 410, as defined by a DSRC/CV2X broadcasting range of an at least one radio of the first RSU 410. The communication zone may provide a 360-degree field of view in which elements within the communication zone (e.g., vehicles, pedestrians, and/or other RSUs) may communicate with the first RSU 410.

A first OBU (not shown) of a first vehicle 417 in proximity to the faulty RSU 410 (e.g., within the communication zone) may receive the distress signal 416. The first OBU may then relay the distress signal as the first vehicle 417 moves through the communication zone of the first RSU 410. The distress signal being relayed by the first OBU of the first vehicle 417 may be received by a second OBU of a second vehicle 427 via vehicle-to-vehicle (V2V) broadcasting.

The second OBU may then similarly relay the distress signal. As the second vehicle 427 passes a second RSU 420, the second RSU 420 may receive the distress signal being relayed from the second OBU of the second vehicle 427. The second RSU 420 may then relay the distress signal 416 to an operation center (not shown) to communicate a faulty status of the first RSU 410. Meanwhile, the second RSU 420 may additionally broadcast a healthy WSA and/or WSM signal to indicate a non-faulty state of the second RSU 420.

The second RSU 420 may also relay the distress signal to OBUs in a communication zone of the second RSU 420 to inform the OBUs of the faulty status of the first RSU 410. For example, prior to entering the communication zone of the second RSU 420, a third OBU of a third vehicle 437 might not receive the distress signal. As the third vehicle 437 approaches a central intersection 450 and thus enters the communication zone of the second RSU 420, the third OBU of the third vehicle 437 may receive the distress signal relayed from the second RSU 420. In some embodiments, the third OBU of the third vehicle 437 may receive the distress signal relayed via V2V communication from the second OBU of the second vehicle 427.

As depicted in FIG. 4, other neighboring intersections (e.g., a first intersection 461, a second intersection 471, a third intersection 481, a fourth intersection 491, and the central intersection 451) are each configured with an RSU. The RSUs for the first intersection 461, the second intersection 471, the third intersection 481, and the fourth intersection 491 may all be functional (e.g., not faulty), while the first RSU 410 of the central intersection 451 may be faulty. The faulty status of the first RSU 410 may be communicated to each of the RSUs of the neighboring intersections by various vehicles and/or by various pedestrians 428, each of which may be configured with an OBU, via V2V and/or V2X wireless communication. Generation, broadcast, receipt, and relay of the distress signal is further described in FIGS. 5-6.

FIG. 5 shows a protocol 500 for broadcasting and detecting an RSU distress signal. The protocol of FIG. 5 may be implemented by a faulty RSU, an OBU, and a nearby RSU, as labeled in protocol 500. In various examples, the faulty RSU may be substantially similar to the first RSU 110, the first RSU 210, and/or the first RSU 410. Similarly, the OBU may be substantially similar to the first OBU of the first vehicle 117, the first OBU of the first vehicle 217, and/or the first OBU of the first vehicle 417. The nearby RSU may be substantially similar to any of the non-faulty RSUs of FIGS. 1, 2, and/or 4.

At 502, protocol 500 includes detection of a fault by the faulty RSU. The fault may be due to backhaul connectivity being down, as described in FIG. 1. Alternatively, the fault may be due to a POE being down, an application being down, or a radio interface being down, as described in FIG. 2. The RSU may be considered partially operational when a first radio (e.g., a primary radio configured for WSA and/or TIM messages) is operational and a second radio (e.g., a radio for additional services including SPaT messages, MAP messages, and so on) is down. A radio may be considered down when radio hardware or software are non-operational or not operating nominally. When the RSU is partially operational, messages configured to be broadcast using the second radio might not be operational and therefore OBUs in the ITS might not be able to receive services (e.g., SPaT messages, MAP messages, and so on) broadcast using the second radio.

The RSU may be considered fully faulty when the first radio is non-operational, not transmitting messages, has a non-operational antenna, or has non-operational hardware. The second radio may be operational; however, without an operational first radio, the RSU may be unable to broadcast messages used to communicate with other elements of the ITS, for example, WSA and/or TIM messages.

At 504, protocol 500 includes invoking a coin cell to provide power to the wireless device. In an example where the POE is down, the coin cell may be used to power elements of the faulty RSU, such as the wireless device.

At 506, protocol 500 includes broadcasting a preconfigured distress message using the wireless device.

At 508, protocol 500 includes maintaining broadcast of the distress message from the faulty RSU by the wireless device until an operator intervention or until the faulty RSU becomes operational.

At 510, which may occur in the OBU following 506 in the faulty RSU, protocol 500 includes receiving the distress message from the faulty RSU. At 512, protocol 500 includes transmitting and/or forwarding the distress message to the nearby RSU. At 514, protocol 500 includes transmitting and/or forwarding the distress message to at least one nearby OBU.

At 516, protocol 500 includes stopping transmission of the distress message after a preconfigured time or after the OBU (e.g., a vehicle or pedestrian device including the OBU) exceeds a preconfigured distance from the faulty RSU (e.g., leaves a communication zone of the faulty RSU).

At 518, which may occur in the nearby RSU following 512 in the OBU, protocol 500 includes receiving the distress message from the OBU informing the nearby RSU of the faulty RSU. At 520, protocol 500 includes enabling a preconfigured TIM message or proprietary message. At 522, protocol 500 includes cautioning passing OBUs (e.g., OBUs other than the OBU to which protocol 500 is applied) about the faulty RSU for a preconfigured time interval. Passing OBUs may be cautioned about the faulty RSU by receiving the TIM message or proprietary message being broadcast by the nearby RSU at 520.

At 524, protocol 500 includes broadcasting the distress message transmission until an operator intervention at the faulty RSU, or until the faulty RSU becomes operational.

Operation of the faulty RSU as described in protocol 500 is elaborated upon in FIG. 6. FIG. 6 shows an example method 600 for detecting a faulty RSU condition and broadcasting an RSU distress signal. Method 600 may be applied to an RSU (such as the RSU 110 of FIG. 1, the RSU 210 of FIG. 2, and/or the RSU 310 of FIG. 3). In various embodiments, method 600 may be applied to a virtual RSU where the RSU may not be a physical structure but instead be a software applied at an operation center that is in communication with various sensors (e.g., cameras, speed detectors, et cetera) of an ITS. In the case of virtual RSUs, detection of a faulty RSU may pertain to non-operational or non-nominally operational function of RSU software, such as broken communication between the RSU software, the operation center, and/or the various sensors, as further described herein.

At 602, method 600 includes monitoring RSU operating conditions. This may include monitoring whether the RSU is powered on or off, monitoring a level of power supplied to the RSU from a wired connection (e.g., POE), monitoring operational states of each of at least two radios of the RSU, and/or monitoring communication between the RSU and elements of the ITS including the operational center and OBUs (e.g., of vehicles, mobile devices, et cetera). Method 600 then proceeds to 618.

At 618, method 600 includes determining if a faulty RSU condition is detected. The faulty RSU condition may include broken communication between the RSU and the operation center, one or more of the radio interfaces of the RSU being non-operational or non-transmitting, and/or one or more enabled applications of the RSU being in a non-running state. If at 618 it is determined a faulty RSU condition is detected, method 600 proceeds to 604. If at 618 it is determined a faulty RSU condition is not detected, method 600 returns to 602 to monitor RSU operating conditions.

At 604, method 600 includes determining a cause of the faulty RSU condition. As described above, the faulty RSU condition may be due to broken communication between the RSU and the operation center, or one or more radio interfaces of the RSU being non-operational and/or non-transmitting, or one or more enabled applications being in a non-running state. Method 600 then proceeds to 605.

At 605, method 600 includes determining if a connection between the RSU and the operation center over a wired interface to a backhaul network is down. This may be the result of, in one example, insufficient power provided by an external source (e.g., POE) to the RSU, a physical disconnect of the wired interface, or non-operation of the operation center or the backhaul network. A status of the connection may be determined by comparing RSU operating conditions monitored at 602 to known nominal operating conditions. If at 605 it is determined the connection between the RSU and the operation center over the wired interface to the backhaul network is down, method 600 proceeds to 606. If at 605 it is determined the connection between the RSU and the operation center over the wired interface to the backhaul network is, method 600 proceeds to 620.

At 606, method 600 includes generating a distress transmission. The distress transmission may be a preconfigured distress message and/or signal indicating a location of the RSU and a type of RSU faulty condition. Method 600 then proceeds to 608.

At 608, method 600 includes broadcasting the distress transmission using power from an RSU internal power cell (e.g., an internal power cell of the RSU). As the faulty RSU condition may be caused by insufficient power from an external source to the RSU, the RSU internal power cell (e.g., the coin cell of FIG. 3) may turn on to provide power to the RSU and invoke an inbuilt DSRC/CV2X and/or Wi-Fi chipset (e.g., the wireless device of FIG. 3) to broadcast the distress transmission to oncoming OBUs at a configured interval. Method 600 then proceeds to 610.

At 610, method 600 includes monitoring RSU operating conditions, including communication between the RSU and the operation center over the wired interface to the backhaul network. Generation and broadcast of the distress transmission may inform passing OBUs and nearby RSUs of the faulty RSU condition, and the nearby RSUs may relay this information to the operation center. The operation center may then dispatch repair to the faulty RSU, may adjust traffic signals to direct OBUs away from the faulty RSU, and/or may broaden a communication range of nearby RSUs to compensate for a lack of communication from the faulty RSU. The cause of the faulty RSU condition—in this case, the connection between the RSU and the operation center over the wired interface to the backhaul network being down—may be repaired following generation and broadcast of the distress transmission. Method 600 then proceeds to 612.

At 612, method 600 includes determining if the faulty RSU condition has ended (e.g., that the RSU has returned to a normal operational state). If it is determined the faulty RSU condition has ended, method 600 proceeds to 616. If it is determined the faulty RSU condition has not ended, method 600 proceeds to 614.

At 614, method 600 includes maintaining broadcast of the distress transmission (e.g., to re-send the predetermined distress transmission). Method 600 then returns to 608.

As discussed above, if at 605 it is determined the connection between the RSU and the operation center over the wired interface to the backhaul network is, method 600 proceeds to 620. At 620, method 600 includes determining the cause of the faulty RSU condition. As described above, the faulty RSU condition may be due to at least one of broken communication between the RSU and the operation center, and one or more of the radio interfaces of the RSU being non-operational and/or non-transmitting, or one or more of enabled applications of the RSU being in a non-running state. Method 600 then proceeds to 622.

At 622, since it was determined at 605 that the cause of the faulty RSU condition is not a broken connection, method 600 includes determining if the RSU radio interface is down. As described in FIG. 3, the faulty RSU may be considered partially operational when a first radio (e.g., a primary radio configured for WSA and/or TIM messages) is operational and a second radio (e.g., a radio for additional services including SPaT messages, MAP messages, et cetera) is down. A radio may be considered down when radio hardware or software are non-operational or not operating nominally. When the faulty RSU is partially operational, messages configured to be broadcast using the second radio may not be operational and therefore OBUs in the ITS may not be able to receive services (e.g., SPaT messages, MAP messages, et cetera) broadcast using the second radio while the faulty RSU may remain in communication with the operation center. The faulty RSU may be considered fully faulty when the first radio is non-operational, not transmitting messages, has a non-operational antenna, or has non-operational hardware. The second radio may be operational; however, without an operational first radio, the RSU may be unable to broadcast messages used to communicate with other elements of the ITS (for example, WSA and/or TIM messages). If at 622 it is determined at least one of the RSU radio interfaces is down, method 600 proceeds to 624. If at 622 it is determined that none of the RSU radio interfaces is down, method 600 returns to 602.

At 624, method 600 includes generating a distress transmission. As described above, the distress transmission may be a preconfigured distress message and/or signal indicating a location of the faulty RSU and a type of RSU faulty condition. Method 600 then proceeds to 626.

At 626, method 600 includes broadcasting the distress transmission using power from a main RSU power source. As a source of the faulty RSU condition may be at least one non-operational radio interface, other elements of the faulty RSU may remain in nominal operation; for example, the faulty RSU may receive power from an external source (e.g., POE), as is the case during nominal RSU operation. The POE may invoke the inbuilt DSRC/CV2X and/or Wi-Fi chipset (e.g., the wireless device of FIG. 3) to broadcast the distress transmission to oncoming OBUs at a configured interval. Method 600 then proceeds to 628.

At 628, method 600 includes monitoring RSU operating conditions, including an operational status of the RSU radio interfaces. Generation and broadcast of the distress transmission may inform passing OBUs and nearby RSUs of the faulty RSU condition, and the nearby RSUs may relay this information to the operation center. The operation center may then dispatch repair to the faulty RSU, may adjust traffic signals to direct OBUs away from the faulty RSU, and/or may broaden a communication range of nearby RSUs to compensate for a lack of communication from the faulty RSU. The cause of the faulty RSU condition—in this case, one or more of the radio interfaces of the faulty RSU being non-operational, or non-transmitting, or one or more enabled applications of the faulty RSU being in a non-running state—may be repaired following generation and broadcast of the distress transmission. Method 600 then proceeds to 630.

At 630, method 600 includes determining if the faulty RSU condition has ended. If it is determined the faulty RSU condition has not ended, method 600 proceeds to 632. If it is determined the faulty RSU condition has ended, method 600 proceeds to 616.

At 632, method 600 includes maintaining broadcast of the distress transmission. Method 600 then returns to 626.

As discussed above, if at 612 or at 630 it is determined that the faulty RSU condition has ended, method 600 proceeds to 616. At 616, method 600 includes halting broadcast of the distress transmission. The faulty RSU condition may end as a result of repairs made to the RSU, operation center, or backhaul network allowing for communication between the RSU and the operation center over the wired interface to the backhaul network to resume nominal operation. Method 600 may then end, after which in various embodiments it may return to 602 again.

Accordingly, as described in FIGS. 5-6, upon detection of a faulty condition of an RSU, the RSU may generate, in response to the detection of the faulty condition, a predetermined distress transmission for broadcast over a wireless interface of the RSU. The distress transmission may include a location of the RSU and information about a cause of the faulty condition. The distress transmission may be received by vehicles and pedestrian devices passing through a communication zone of the faulty RSU, the vehicles and devices each configured with an OBU. The OBUs transmit and/or forward the distress transmission to other nearby OBUs and nearby RSUs to inform the OBUs and RSUs of the faulty RSU. Transmission and/or forwarding of the distress transmission by the OBUs may end after a pre-configured time or a pre-configured distance (e.g., beyond the faulty RSU communication zone). The nearby RSUs may forward the distress transmission to the operation center to inform the operation center of the faulty RSU condition. Additionally, the nearby RSU may transmit and/or forward the distress transmission to nearby OBUs for a pre-configured time interval to inform the OBUs of the faulty RSU condition. The distress transmission by the faulty RSU may be stopped upon detection that the faulty RSU condition has ended.

In this way, OBUs within a communication zone of the faulty RSU are informed of the faulty RSU status and may transmit information about the faulty RSU to nearby RSUs and other OBUs. Nearby non-faulty RSUs may then forward information about the faulty RSU to the operation center. This may result in the operation center adjusting commands relayed to OBUs via RSUs, for example, changing a travel path of a vehicle configured with the OBU, adjusting traffic signals, adjusting the vehicle speed, and so on. Additionally, the operation center may broaden a range (e.g., a communication zone) of nearby RSUs to compensate for the faulty RSU and monitor OBUs of vehicles and other devices within the communication zone of the faulty RSU.

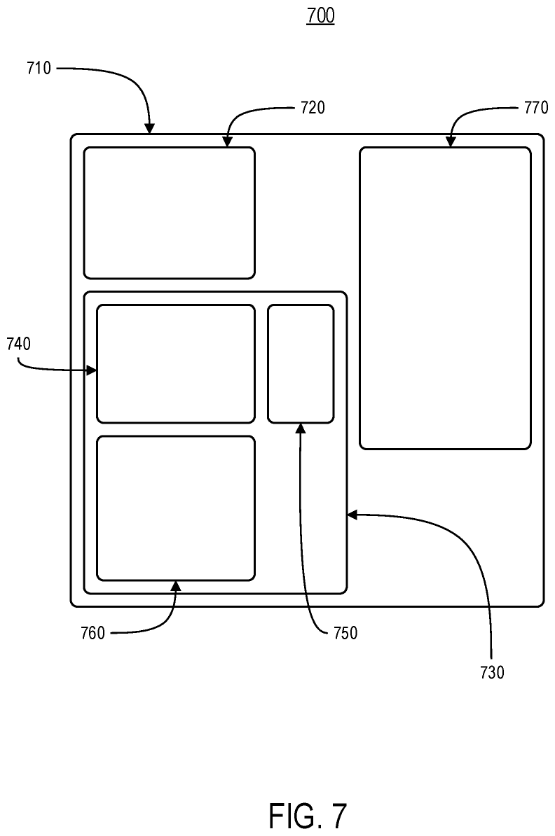

FIG. 7 shows a system 700 for a system for detection and indication of faulty RSUs. System 700 may comprise a case 710, a power source 720, an interconnection board 730, one or more processors 740, one or more memory devices 750, one or more input/output (I/O) interfaces 760, and/or one or more media drives 770.

Case 710 may be any type of enclosure for other portions of system 700. In some embodiments, case 710 may have a form suitable for use as a case for a personal computer (e.g., a desktop computer). In other embodiments, case 710 may have a form suitable for insertion into a rack of components (e.g., a server blade).

Various processors included in processors 740 may have one or more Central Processing Units (CPUs) and/or microprocessors. Each of the CPUs and/or microprocessors may in turn have any number of processing cores, and each core may be operable to process one or more threads at a time. In various embodiments, the CPUs and/or microprocessors may include any of a Digital Signal Processor (DSP), a Graphics Processing Unit (GPU), a network processor, and/or other special-purpose processors, coprocessors, or units.

Memory devices 750 may include devices based upon any of a variety of storage technologies. In various embodiments, memory devices 750 may include magnetic-disk-based storage and/or optical-disk-based storage. Memory devices 750 may also include various types of Random Access Memory (RAM) based storage, such as Dynamic RAM (DRAM) based storage. In some embodiments, memory devices 750 may include non-volatile memory, such as flash memory, or phase-change memory (PCM). Media drives 770 may also include devices based on, for example, magnetic-disk-based storage technologies and/or optical-disk-based storage technologies. Memory devices 750 may have executable instructions stored therein that, when executed, cause processors 740 to perform various operations, as disclosed herein.

I/O interfaces 760 may include electronic interfaces operable to be communicatively coupled to I/O devices, using electronics developed for various I/O technologies (e.g., bus specifications, interconnect specifications, and the like). I/O interfaces may include propriety interconnect configurations, as well as interfaces complying with, e.g., a Universal Serial Bus (USB) protocol, a Serial Advanced-Technology Attachment (SATA) bus protocol, a Peripheral Component Interconnect (PCI) Express protocol, and the like. Some I/O interfaces 760 may connect components within system 700 to each other, while other I/O interfaces 760 may connect components within system 700 to other devices external to system 700. I/O interfaces 760 may also include one or more wired internet connections (e.g., Ethernet connections) and/or one or more interfaces for wireless connections (e.g., Wi-Fi and/or cellular connections).

Power source 720 may be operable to provide electrical power to processors 740, memory devices 750, I/O interfaces 760, end/or media drives 770. Meanwhile, interconnection board 730 may electrically and/or electronically couple power source 720, processors 740, memory devices 750, I/O interfaces 760, and/or media drives 770. Interconnection board 730 may, for example, include a motherboard, or other printed circuitry board (PCB) used for providing power to and/or interconnecting various electronic devices.

System 700 (and/or other systems and devices disclosed herein) may be configured in accordance with the systems discussed herein. For example, system 700 may be employed in a scenario substantially similar to the first scenario of a faulty RSU mechanism in FIG. 1, the second scenario of a faulty RSU mechanism in FIG. 2, and/or the scenario in which a faulty RSU mechanism communicates a distress signal in FIG. Moreover, system 700 may include an architecture substantially similar to the architecture of RSU, may undertake a protocol substantially similar to protocol 500, and/or may undertake a method substantially similar to method 600. Thus, the various advantages that apply to the these scenarios, methods, and protocols as discussed herein may apply to system 700.

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices, such as RSUs 110 and 120 of FIG. 1, RSUs 210 and 220 of FIG. 2, and RSU 310 of FIG. 3. The methods may be performed by executing stored instructions with one or more logic devices (e.g., processors) in combination with one or more additional hardware elements, such as storage devices, memory, hardware network interfaces and/or antennas, switches, actuators, clock circuits, and so on. The described methods and associated actions may also be performed in various orders in addition to the order described in this application, in parallel, and/or simultaneously. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

The disclosure provides support for a method comprising: detecting a faulty condition of an RSU, and generating, in response to the detection of the faulty condition of the RSU, a predetermined distress transmission for broadcast over a wireless interface of the RSU. In a first example of the method, the faulty condition of the RSU includes a connection between the RSU and an operation center over a wired interface to a backhaul network being down. In a second example of the method, optionally including the first example, the method further comprises: broadcasting the predetermined distress transmission over the wireless interface using power from an internal power cell of the RSU. In a third example of the method, optionally including one or both of the first and second examples, the faulty condition of the RSU includes a radio interface of the RSU being down. In a fourth example of the method, optionally including one or more or each of the first through third examples, the method further comprises: broadcasting the predetermined distress transmission over the wireless interface using power from a main power source of the RSU. In a fifth example of the method, optionally including one or more or each of the first through fourth examples, the wireless interface is operable to transmit WSA messages. In a sixth example of the method, optionally including one or more or each of the first through fifth examples, the predetermined distress transmission includes at least one of: a unique RSU identifier (ID), a three-dimensional (3D) location, and an intersection ID. In a seventh example of the method, optionally including one or more or each of the first through sixth examples, the method further comprises: detecting that the faulty condition of the RSU has ended, and halting a broadcasting of the predetermined distress transmission based on the detection that the faulty condition of the RSU has ended.

The disclosure also provides support for an apparatus of a roadside unit (RSU), comprising: a wireless interface for sending transmissions to on board units (OBUs), one or more processors, and a non-transitory memory having executable instructions that, when executed, cause the one or more processors to: detect a faulty condition of the RSU, generate, in response to the detection of the faulty condition of the RSU, a predetermined distress transmission, and broadcast the predetermined distress transmission over the wireless interface. In a first example of the system, the faulty condition of the RSU includes a connection between the RSU and an operation center over a wired interface to a backhaul network being down, and wherein an internal power cell of the RSU provides power for the broadcasting of the predetermined distress transmission over the wireless interface. In a second example of the system, optionally including the first example, the system further comprises: wherein the faulty condition of the RSU includes a radio interface of the RSU being down, and wherein a main power source of the RSU provides power for the broadcasting of the predetermined distress transmission over the wireless interface. In a third example of the system, optionally including one or both of the first and second examples, the radio interface is a first radio interface, wherein the first radio interface is compliant with at least one of: a WSA protocol, a TIM protocol, and a regional wireless communication standard, and wherein a second radio interface of the RSU is compliant with at least one of: a SPaT message protocol, and a protocol for MAP messages. In a fourth example of the system, optionally including one or more or each of the first through third examples, the wireless interface is compliant with at least one of: a DSRC protocol, a V2X protocol, a Wi-Fi DSRC protocol, a 4G cellular-V2X protocol, and a 5G protocol. In a fifth example of the system, optionally including one or more or each of the first through fourth examples, a coverage range of a protocol of the wireless interface is substantially the same as a coverage range of the RSU. In a sixth example of the system, optionally including one or more or each of the first through fifth examples the executable instructions, when executed, further cause the one or more processors to: halt broadcasting of the predetermined distress transmission based on a detection that the RSU has returned to a normal operational state.

The disclosure also provides support for a system for detection and indication of faulty RSUs, comprising: an RSU comprising one or more first processors, and a first non-transitory memory having first executable instructions that, when executed, cause the one or more first processors to: detect a faulty condition of the RSU, and generate, in response to the detection of the faulty condition of the RSU, a predetermined distress transmission for OBUs, and broadcast the predetermined distress transmission over a wireless interface, and an OBU comprising one or more second processors, and a second non-transitory memory having second executable instructions that, when executed, cause the one or more second processors to: process the predetermined distress transmission. In a first example of the system, the faulty condition of the RSU includes a connection between the RSU and an operation center over a wired interface to a backhaul network being down, and wherein the broadcasting of the predetermined distress transmission over the wireless interface uses power from an internal power cell of the RSU. In a second example of the system, optionally including the first example, the faulty condition of the RSU includes a radio interface of the RSU being down, and wherein the broadcasting of the predetermined distress transmission over the wireless interface uses power from a main power source of the RSU. In a third example of the system, optionally including one or both of the first and second examples, the RSU is a first RSU, and wherein the second executable instructions, when executed, further cause the one or more second processors to: re-send the predetermined distress transmission to a second RSU. In a fourth example of the system, optionally including one or more or each of the first through third examples, the OBU is a first OBU, and wherein the second RSU comprises one or more third processors, and a third non-transitory memory having third executable instructions that, when executed, cause the one or more third processors to: re-send the predetermined distress transmission to a second OBU.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” and so on. are used merely as labels, and are not intended to impose numerical requirements or a particular positional order on their objects. The following claims particularly point out subject matter from the above disclosure that is regarded as novel and non-obvious.

1. A method comprising:
detecting a faulty condition of a roadside unit (RSU); and
generating, in response to the detection of the faulty condition of the RSU, a predetermined distress transmission for broadcast over a wireless interface of the RSU.

2. The method of claim 1, wherein the faulty condition of the RSU includes a connection between the RSU and an operation center over a wired interface to a backhaul network being down.

3. The method of claim 2, further comprising:
broadcasting the predetermined distress transmission over the wireless interface using power from an internal power cell of the RSU.

4. The method of claim 2, wherein the faulty condition of the RSU includes a radio interface of the RSU being down.

5. The method of claim 4, further comprising:
broadcasting the predetermined distress transmission over the wireless interface using power from a main power source of the RSU.

6. The method of claim 1, wherein the wireless interface is operable to transmit wireless access in vehicular environments (WAVE) service advertisement (WSA) messages.

7. The method of claim 1, wherein the predetermined distress transmission includes at least one of: a unique RSU identifier (ID); a three-dimensional (3D) location; and an intersection ID.

8. The method of claim 1, further comprising:
detecting that the faulty condition of the RSU has ended; and
halting a broadcasting of the predetermined distress transmission based on the detection that the faulty condition of the RSU has ended.

9. An apparatus of a roadside unit (RSU), comprising:
a wireless interface for sending transmissions to on board units (OBUs);
one or more processors; and
a non-transitory memory having executable instructions that, when executed, cause the one or more processors to:
detect a faulty condition of the RSU;
generate, in response to the detection of the faulty condition of the RSU, a predetermined distress transmission; and
broadcast the predetermined distress transmission over the wireless interface.

10. The apparatus of the RSU of claim 9, wherein the faulty condition of the RSU includes a connection between the RSU and an operation center over a wired interface to a backhaul network being down; and wherein an internal power cell of the RSU provides power for the broadcasting of the predetermined distress transmission over the wireless interface.

11. The apparatus of the RSU of claim 9, further comprising: wherein the faulty condition of the RSU includes a radio interface of the RSU being down; and wherein a main power source of the RSU provides power for the broadcasting of the predetermined distress transmission over the wireless interface.

12. The apparatus of the RSU of claim 11, wherein the radio interface is a first radio interface,
wherein the first radio interface is compliant with at least one of: a wireless access in vehicular environments (WAVE) service advertisement (WSA) protocol, a traveler information messages (TIM) protocol, and a regional wireless communication standard; and
wherein a second radio interface of the RSU is compliant with at least one of: a signal phase and timing (SPaT) message protocol, and a protocol for messages corresponding with map data to convey geographic road information (MAP messages).

13. The apparatus of the RSU of claim 9, wherein the wireless interface is compliant with at least one of: a dedicated short-range communication (DSRC) protocol, a vehicle-to-everything (V2X) protocol, a Wi-Fi DSRC protocol, a 4G cellular-V2X protocol, and a Fifth Generation broadband cellular network (5G) protocol.

14. The apparatus of the RSU of claim 9, wherein a coverage range of a protocol of the wireless interface is substantially the same as a coverage range of the RSU.

15. The apparatus of the RSU of claim 9, the executable instructions, when executed, further cause the one or more processors to:
halt broadcasting of the predetermined distress transmission based on a detection that the RSU has returned to a normal operational state.

16. A system for detection and indication of faulty roadside units (RSUs), comprising:
an RSU comprising one or more first processors, and a first non-transitory memory having first executable instructions that, when executed, cause the one or more first processors to:
detect a faulty condition of the RSU; and
generate, in response to the detection of the faulty condition of the RSU, a predetermined distress transmission for on-board units (OBUs); and
broadcast the predetermined distress transmission over a wireless interface; and
an OBU comprising one or more second processors, and a second non-transitory memory having second executable instructions that, when executed, cause the one or more second processors to:
process the predetermined distress transmission.

17. The system of claim 16, wherein the faulty condition of the RSU includes a connection between the RSU and an operation center over a wired interface to a backhaul network being down; and wherein the broadcasting of the predetermined distress transmission over the wireless interface uses power from an internal power cell of the RSU.

18. The system of claim 16, wherein the faulty condition of the RSU includes a radio interface of the RSU being down; and wherein the broadcasting of the predetermined distress transmission over the wireless interface uses power from a main power source of the RSU.

19. The system of claim 16, wherein the RSU is a first RSU; and wherein the second executable instructions, when executed, further cause the one or more second processors to:
re-send the predetermined distress transmission to a second RSU.

20. The system of claim 19, wherein the OBU is a first OBU; and wherein the second RSU comprises one or more third processors, and a third non-transitory memory having third executable instructions that, when executed, cause the one or more third processors to:
re-send the predetermined distress transmission to a second OBU.
